(19) United States
(12) Patent Application Publication
(10) Pub. No.: US 2018/0241297 A1
(43) Pub. Date: Aug. 23, 2018

(54) SYSTEM AND METHOD FOR GENERATOR BRAKING USING LAMINATED BRAKE COMPONENTS

(71) Applicant: GENERAL ELECTRIC COMPANY, Schenectady, NY (US)

(72) Inventors: Christoph BOELD, Garching b. Munchen, Bayern (DE); Mikhail Avramovich AVANESOV, Garching b. Munchen, Bayern (DE); Stefan SCHROEDER, Garching b. Munchen, Bayern (DE); Ara PANOSYAN, Garching b. Munchen, Bayern (DE); Herbert SCHAUMBERGER, Jenbach (AT); Uwe LIEBSCHER, Jenbach (AT)

(21) Appl. No.: 15/751,167

(22) PCT Filed: Aug. 10, 2015
(86) PCT No.: PCT/US2015/044505

§ 371 Date: Feb. 8, 2018

(51) Int. Cl. H02K 49/04; H02P 3/04; H02P 9/10; H02K 15/02; H02K 7/104

(52) U.S. Cl. CPC H02K 49/046; H02P 3/04; H02K 7/104; H02K 15/026; H02P 9/102

(57) ABSTRACT

A system includes an eddy current brake. The eddy current brake includes a back plate and a first inductor. The first inductor includes a pole coupled to the back plate and a winding disposed about the pole, wherein the winding is configured to conduct an electric current to generate a magnetic field. At least one of the back plate and the pole 104 includes a plurality of laminations.

### TECHNOLOGY FIELD

The subject matter disclosed herein relates generally to a power generation system and more specifically to electromagnetic braking of a generator of the power generation system during a low voltage ride through (LVRT) event.

### BACKGROUND

A power grid collects power generated from multiple generators and transmits the power to different locations. During operation, grid disturbances may occur, which may be due to faults and decrease the voltage in a utility system. A sudden reduction in voltage at the point of interconnection of a generator and the grid may result in a sudden reduction of the electrical power output of the generator. As a consequence, there may be a greater mechanical power input from an engine coupled to the generator compared to the electrical power output of the generator. This may cause the rotational speed of the generator to accelerate, leading to a loss of synchronism between the generator and the grid. Moreover, disconnecting the generator may reduce the stability of the grid.

As a result, some grid codes specify that generators “ride through” certain voltage conditions caused by grid fault events. As may be appreciated, the phrase “ride through” as utilized herein may be defined as to continue operating without disconnecting from the grid. This capability is referred to as an LVRT or fault ride through (FRT). Various types of loads may be applied to the generator to reduce the difference in mechanical input and electrical output from the generator. Unfortunately, known electromagnetic braking systems suffer from delay in braking response time.

### BRIEF DESCRIPTION

Embodiments set forth herein are not intended to limit the scope of this disclosure, but rather these embodiments are intended only to provide a brief summary thereof. Indeed, the scope of this disclosure may encompass a variety of forms that may be similar to or different from the embodiments set forth below.

In one embodiment, a system includes an eddy current brake. The eddy current brake includes a back plate and a first inductor. The first inductor includes a pole coupled to the back plate and a winding disposed about the pole, wherein the winding is configured to conduct an electric current to generate a magnetic field. At least one of the back plate and the pole includes a plurality of laminations.

In another embodiment, a system includes an electromagnetic braking system. The electromagnetic braking system includes an eddy current brake that in turn includes an electrically conductive surface coupled to a shaft of a generator system, a back plate and a plurality of inductors coupled to the back plate. Each inductor includes a pole coupled to the back plate and a winding disposed about the pole, wherein the winding is configured to conduct an electric current to generate a first magnetic field. At least one of the back plate and each respective pole includes a plurality of laminations.

In another embodiment, a method includes monitoring a load parameter of the power generation system, determining a start of a ride through event based at least in part on a first change to the load parameter, and applying an eddy current brake to load the power generation system through the ride through event. Applying the eddy current brake includes supplying an electric current to a winding of the eddy current brake, wherein the electric current includes at least 70 percent of a steady-state current value within a threshold time period of the start of the ride through event. Applying the eddy current brake also includes inducing, via the current through the winding, an electromagnetic force on an electrically conductive surface of the eddy current brake. The eddy current brake includes the electrically conductive surface, a back plate and a pole coupled to the back plate, and at least one of the back plate and the pole includes a plurality of laminations.

### BRIEF DESCRIPTION OF THE DRAWINGS

Other features and aspects of the present disclosure will become better understood when the following detailed description is read with reference to the accompanying drawings in which like characters represent like parts throughout the drawings, wherein:

FIG. 1 is a plot of a voltage limit curve at a point of connection of a power generation system to a grid during an LVRT event;

FIG. 2 is a block diagram of an embodiment of the power generation system with an electromagnetic braking system;

FIG. 3 is a cross-section of an inductor portion of an embodiment of the electromagnetic braking system;

FIG. 4 is an axial view of a solid back plate of an embodiment of the electromagnetic braking system;

FIG. 5 is an axial view of a laminated back plate of an embodiment of the electromagnetic braking system;

FIG. 6 is an axial view of another laminated back plate of an embodiment of the electromagnetic braking system;

FIG. 7 is an axial view of a laminated pole of an embodiment of the electromagnetic braking system;

FIG. 8 is a cross-sectional view of a laminated pole of an embodiment of the electromagnetic braking system; and

FIG. 9 is a chart illustrating the response time of various embodiments of the electromagnetic braking system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

It is desirable for generators, such as distributed energy resource (DER) systems, to remain synchronized to a power grid, “ride through” low voltage fault conditions, and feed power into the grid immediately after the fault is cleared due to grid codes enforcing such restrictions. DER systems are small generators, typically in a range from 3 kW to 10,000 kW, that generate power from various sources and transfer the generated power to the connected power grid. DER systems are typically an alternative or enhancement to traditional electric power systems. DER systems may reduce the amount of energy lost in transmitting electricity because the electricity may be generated very close to where it is used. As may be appreciated, the phrase “ride through” as utilized herein may be defined as to continue operating without disconnecting from the grid. This capability is referred to as low voltage ride through (LVRT) or fault ride through (FRT). Various embodiments of systems and methods for electromagnetic braking of a power generator during an LVRT event are presented. These various embodiments rapidly control a rotational speed of a shaft of a power generation system within a desired time period, which in turn provides effective ride through capabilities in the power generation system, by using at least one laminated portion of an electromagnetic brake (e.g., eddy current brake). The at least one laminated portion of the eddy current brake may be a pole portion of one or more inductors, a back plate (or yoke) portion, or any combination thereof. As discussed further below, laminating a portion of the eddy current brake reduces eddy currents generated in the laminated portion as a result of supplying current to one or more windings of the eddy current brake. Reducing the eddy currents generated in the laminated portion may increase the speed of generating a magnetic field that provides the braking force. The benefits may include a faster braking response time and, consequently, less energy expended in braking.

FIG. 1 illustrates a plot 10 of a voltage limit curve at the point of connection (POC) of the power generation system to the grid during the LVRT event. For example, the LVRT event may be caused by lightning or wind storms knocking down or otherwise damaging transmission lines. These faults may cause a voltage decrease of a magnitude and duration, depending on the type and severity of the fault and the distance of the fault from the POC. Grid codes may specify that the generators remain connected if the voltage decrease is of a certain magnitude and duration at the POC. For example, grid codes may specify generators stay connected when the voltage decrease is between 75% and 100%, 80% and 95%, or 85% and 90%, and the duration is between 50 ms and 5 seconds, 100 ms and 4 seconds, or 150 ms and 3 seconds. Ensuring that generators stay connected to the grid prevents increasing the voltage decrease via disconnection, which could otherwise increase system instability.

The plot 10 shows a horizontal axis 12 representing time in milliseconds and a vertical axis 14 representing voltage in percentage of pre-LVRT event voltage (e.g., 400 V, 690 V). The LVRT event occurs at 0 ms. Before the LVRT event, the system is in a steady-state and the pre-LVRT event voltage 16 at the POC (i.e., before 0 ms) is 100% or 1 per unit. During steady-state, a prime mover of the power generation system, the shaft, and generator are synchronous with the grid. When the LVRT event occurs, the voltage 18 at 0 ms may drop down to as low as 5% of a steady-state voltage. In this example, the grid codes specify that the generator stay connected with the grid even when the voltage drops by 95%, to as low as 5%. It should be noted that the voltage at the POC is based at least in part on the electrical distance of the fault from the POC, the type and severity of the fault, and so forth. In some embodiments, the voltage decrease during the LVRT event may be between 75% and 100%, 80% and 95%, or 85% and 90%.

When the LVRT event occurs, as illustrated at 0 ms in FIG. 1, the amount of electrical power delivered by the generator into the grid typically decreases as well. If a mechanical power produced by the prime mover is not reduced, the mechanical power delivered to the generator by the prime mover exceeds the electrical power delivered by the generator into the grid. The difference in the mechanical power delivered to the generator and the electrical power taken out from the generator may be exhibited as acceleration of the prime mover, the shaft coupling the prime mover to the generator, and the generator. Increasing the speed of the generator above a synchronous speed may increase a generator rotor angle.

The generator rotor angle is the angle between the magnetic field of the generator rotor and the magnetic field produced in the stator coils of the generator. During normal (and synchronized) operation, the magnetic fields are nearly aligned (e.g., between 10° and 60° from full alignment), and the magnetic field of the rotor will advance with respect to magnetic field of the stator coils. The angle of the advancement of the magnetic field of the generator rotor with respect to the magnetic field of the stator coils is the rotor angle. If the LVRT event is long enough, the speed of the rotor of the generator will increase to the point that the rotor angle reaches 90°. If the rotor angle reaches 90°, synchronism of the rotor and generator is lost. The generator may not return to synchronism after the LVRT if the rotor angle reached 90° during the LVRT. If the generator is not disconnected from the grid when the rotor angle reaches 90°, the generator may output high transient current peaks to the POC. Continued operation, despite loss of synchronism, may result in the rotor experiencing a sudden physical and electrical shift in position relative to the stator, after which the field recovers enough strength to lock the rotor back in synch with the stator (known as pole slipping). The violent acceleration and deceleration associated with pole slipping causes enormous stress on the generator and prime mover, and may result in winding movement to shaft fracture.

If the generator loses synchronism with the grid, the generator will typically be disconnected from the grid so that it can be resynchronized and reconnected to the grid. However, disconnecting the generator from the grid may result in noncompliance with the grid code. Applying a braking force to the shaft to maintain the generator rotor speed close to a synchronous speed or below a threshold speed may enable the generator to comply with the grid code. As may be appreciated, compliance with the grid code may facilitate maintaining synchronism between the generator and the POC, thereby enabling the generator to continue supplying power to the grid during and after the LVRT event.

In FIG. 1, the LVRT event duration 18 is shown as 150 ms. It is appreciated that the duration of the LVRT event can be within a range of time. For example, the LVRT event duration could be between approximately 1 ms to 300 ms, 10 ms to 200 ms, or 50 ms to 150 ms. In this example, at 150 ms, the fault is cleared or a zone protection is activated 20, thus the voltage increases to 20% of the steady-state voltage. A zone protection is an isolation scheme of the grid that serves to detect and isolate a fault section of the grid such that the section continues operating without disabling the entire grid. Further at 500 ms in the illustrated embodiments, other zone protections are activated 22, thereby enabling the voltage to return to 90% steady-state voltage within 1500 ms.

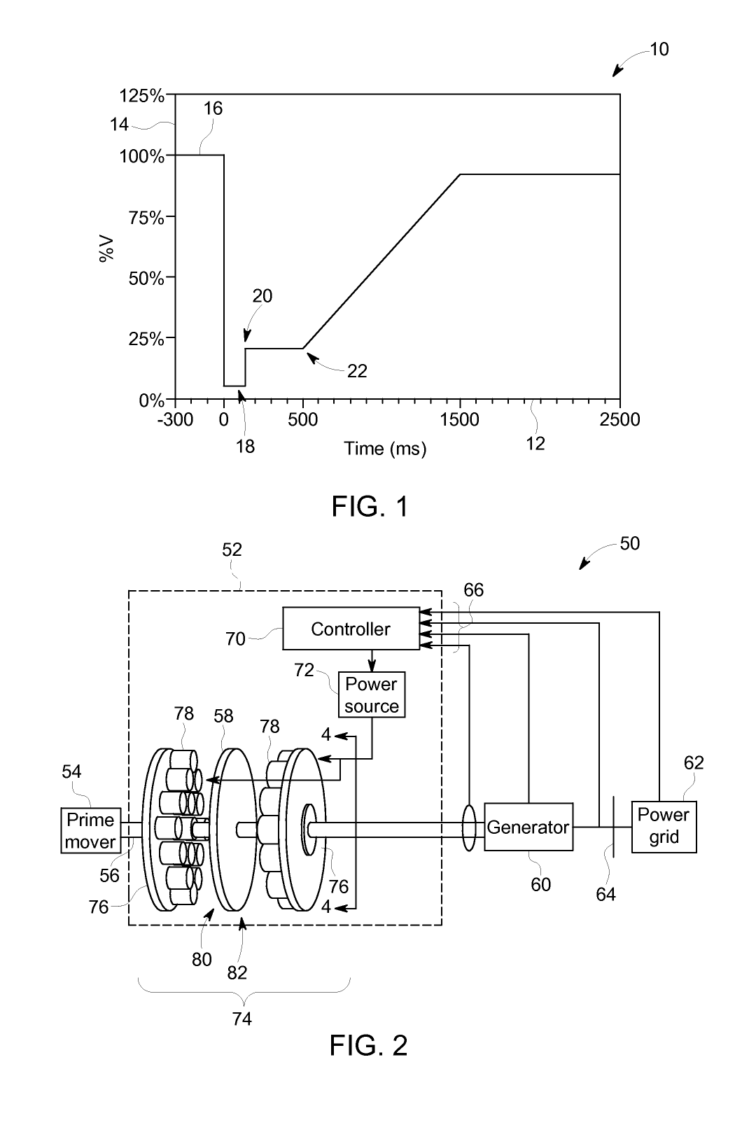

FIG. 2 is a block diagram of an embodiment of the power generation system 50. The power generation system 50 is typically used to convert mechanical power into electrical power. For example, in a wind system, the kinetic energy of wind passing across a wind turbine is converted into mechanical power. Other non-limiting examples of applicable power generation systems 50 include gas turbines, gas engines, diesel engines, and reciprocating engines. The converted mechanical power is in turn used to generate electrical power.

The power generation system 50 includes the prime mover 54, the shaft 56, the generator 60, and an electromagnetic braking system 52. The generator 60 provides electrical power to the grid 62. The prime mover 54 is mechanically coupled to the generator 60 via the shaft 56. The shaft 56 is typically used to convey the mechanical power from the prime mover 54 to the generator 60. For example, the mechanical power from the prime mover 54 may be used to rotate the shaft 56 at a predetermined speed during steady-state operation. This rotation of the shaft 56 in turn rotates the rotor of the generator 60 to generate electrical power. The electrical power generated at the generator 60 is transferred to the grid 62 at the POC 64. The grid 62 collects the power generated from one or more generators and transmits the collected power to different locations for use.

During operation of the power generation system 50, the voltage at the POC 64 may decrease below a predetermined level, as depicted in FIG. 1, due to one or more LVRT events in the grid 62. As a result, the electrical power delivered to the grid 62 by the generator 60 to the grid 62 will likely be reduced. If the mechanical power delivered by the prime mover 54 to the generator 60 is not reduced accordingly, then the mechanical power surplus will accelerate the shaft 56 of the prime mover 54 and the generator 60. Consequently, the rotor speed of the generator 60 may increase if the mechanical power delivered to the generator 60 is not reduced. Increasing the rotor speed may increase the generator rotor angle, potentially losing synchronism between the generator 60 and the grid 62 as discussed above. Unless the mechanical power delivered by the prime mover 54 to the generator 60 is reduced, the generator 60 may be disconnected from the grid 62 and fail to comply with the grid code.

However, to ride through LVRT events and comply with the grid code, the electromagnetic braking system 52 is employed to aid the power generation system 50 to maintain synchronism between the generator 60 and the grid 62 by controlling the rotational speed of the shaft 56. Particularly, the electromagnetic braking system 52 monitors one or more load parameters via inputs 66 of the power generation system 50. The one or more load parameters may include, but are not limited to the rotational speed of the shaft 56, a voltage in the grid 62, a current at the generator 60, the mechanical power produced by the prime mover 54, the rotor angle of the generator 60, or the electrical power produced by the generator 60, or any combination thereof. The one or more load parameters may also indicate one or more conditions, including LVRT events, in the power generation system 50 and/or the grid 62.

The electromagnetic braking system 52 may include, but is not limited to, a controller 70, a power source 72, and the electromagnetic brake (e.g., an eddy current brake 74). The controller 70 may be configured to determine a start of the LVRT event based at least in part on a first change to the one or more load parameters received via the inputs 66.

Upon determining that the LVRT event started, the controller 70 may be configured to direct the eddy current brake 74 to apply the electromagnetic braking force on an electrically conductive surface 58 (e.g., disc) of the eddy current brake 74. The electrically conductive surface 58 may be coupled to the shaft 56 of the power generation system 50. The conductive material used for the electrically conductive surface 58 (e.g., a disc) may include, but is not limited to copper, aluminum, steel, or any combination thereof. The electrically conductive surface 58 may be a small and light disc such that the disc itself has a negligible effect on the inertia of the generator 60. In some embodiments, the electrically conductive surface 58 may have a thickness of between approximately 0.1 cm to 5 cm, 0.5 cm to 3 cm, or 1 cm to 2 cm. In some embodiments, the electrically conductive surface 58 may have an outer diameter between approximately 40 cm to 140 cm, 60 cm to 120 cm, or 80 cm to 100 cm. The dimensions of the electrically conductive surface 58 may vary depending on the type of application, and thus, should not be intended as limited to the disclosed embodiments. Because the electrically conductive surface 58 is rigidly coupled to the shaft 56, the rotational speed of the shaft 56 may be controlled by controlling the rotational speed of the electrically conductive surface 58.

In some embodiments, the eddy current brake 74 further includes the one or more inductors 78 coupled (e.g., mounted) to the back plate 76. The one or more inductors 78 may each include a pole around which are wound one or more electrical windings (e.g., coils) that are disposed proximate to the electrically conductive surface 58. For example, the one or more inductors 78 may be disposed within about 0.5 to 20 mm, 2.5 to 10 mm, or 3.5 to 6.5 mm of the electrically conductive surface 58. In some embodiments, the one or more inductors 78 may be arranged in one or more layers facing the electrically conductive surface 58. However, the one or more inductors 78 may also be arranged in one or more groups facing either one side 80 of the electrically conductive surface 58 or both the sides 80, 82 of the electrically conductive surface 58. The back plate 76 may be made of a magnetically conductive material, such as steel, iron, or a combination thereof. The one or more windings may be made of copper and are coupled to the power source 72. Discharge of the power source 72 supplies current to the eddy current brake 74, such that current from the power source 72 is supplied through the one or more electrical windings and cause the one or more inductors 78 to generate a first magnetic field.

Additionally, the power source 72 may be configured to supply a threshold current to the eddy current brake 74 within a threshold period of the start of the LVRT event. For example, the power source 72 may be configured to supply the threshold current of between approximately 70% to 95% of the final current value, which can be in the range of 100 A to 2000 A, to the eddy current brake 74 to the eddy current brake 74. Moreover, the power source 72 may be configured to supply the threshold current to the eddy current brake 74 within approximately 50 ms, 30 ms, 20 ms, 10 ms, or 5 ms, or less, of determining the start of the LVRT event.

The first magnetic field generated in the one or more inductors 78 induces eddy currents inside the rotating electrically conductive surface 58 (e.g., disc). The induced eddy currents in the disc produce a second magnetic field. The first magnetic field opposes the second magnetic field, thus resisting the rotation of the electrically conductive surface 58 to provide the braking force on the shaft 56. By resisting the rotation of the electrically conductive surface 58, the electromagnetic braking system 52 controls the rotational speed of the shaft 56 to be below the threshold speed to maintain synchronism between the generator 60 and the grid 62. In some examples, if the rotational speed of the shaft 56 is above the threshold speed, the electromagnetic braking system 52 applies the braking force to the shaft 56 via the electrically conductive surface 58 (e.g., disc) to slow the shaft 56 and to maintain synchronism between the generator 60 and the grid 62. That is, the electromagnetic braking system 52 may maintain the rotational speed of the shaft 56 below the threshold speed, thereby enabling the generator 60 to maintain synchronism with the grid 62 in compliance with the grid code.

The braking response time of the electromagnetic braking system 52 may affect the duration of acceleration of the shaft 56, and thereby affect the total amount of braking force exerted (and energy expended) to maintain synchronism of the generator 60 to the grid 62. Specifically, the less time it takes for the electromagnetic braking system 52 to apply braking force, the less time the shaft 56 will have to accelerate. The rotational speed of the shaft 56 will thus be lower at the time when the braking force is applied. As a result, compared to a power generation system that has an electromagnetic braking system with a longer response time, it will take less exerted braking force (and expended braking energy) to bring the rotational speed of the shaft 56 below the threshold speed.

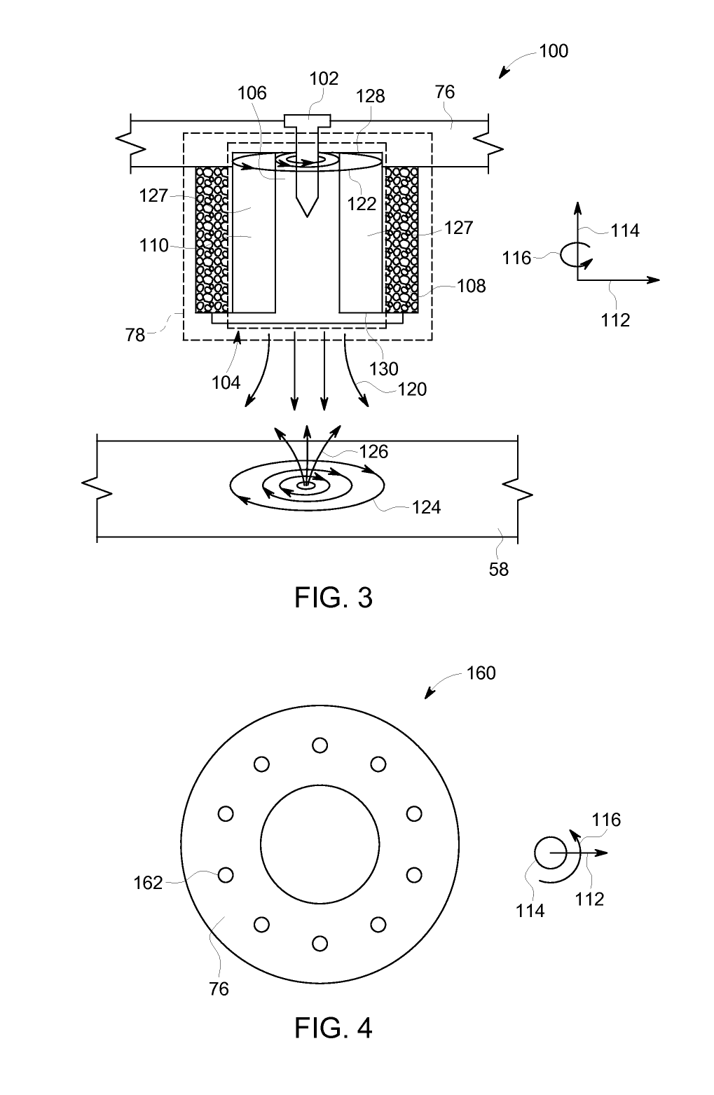

FIG. 3 is a cross-section of an inductor portion 100 of an embodiment of the electromagnetic braking system 52. The inductor portion 100 includes one inductor 78 coupled to the back plate 76 with a fastener 102 (e.g., a screw or bolt). The electromagnetic braking system 52 may include many such inductor portions 100 arranged as described above. Other types of fasteners 102 may include welds, glues, adhesives, mating geometries, etc. The inductor 78 includes the pole 104, which includes a pole core 106, and windings 108. The pole 104 may be made of a magnetic material, such as iron or ferrite. As discussed above, the one or more electrical windings (e.g., coils) 108 are wrapped around the pole 104. The one or more windings 108 may be made of an electrically conductive material, such as copper or aluminum.

When the electromagnetic braking system 52 applies braking force, the power source 72 supplies current to the one or more electrical windings 108, which results in two notable effects. First, the steady-state current in the one or more electrical windings 108 induces the first magnetic field 120 in a direction along the axis 114. The first magnetic field 120 penetrates the pole 104 and the back plate 76, which aids the inducement of the first magnetic field 120. Second, the first magnetic field 120 induces eddy currents 124 inside the rotating electrically conductive surface 58. The eddy currents 124 in the rotating electrically conductive surface 58 may be in a circumferential direction 116, perpendicular to the direction of the first magnetic field 120 (i.e., along axis 114). The eddy currents 124 in the rotating electrically conductive surface 58 may thereby producing a second magnetic field 126 in the rotating electrically conductive surface 58 in a direction along the axis 114 that opposes the first magnetic field 120. However, supplying current to the one or more electrical windings 108 also generates eddy currents 122 to build up in the pole 104 and the back plate 76 during a transient period in which the current supplied to the one or more electrical windings 108 increases to a desired value. The eddy currents 122 in the pole 104 and the back plate 76 may be in the circumferential direction 116, perpendicular to the direction of the first magnetic field 120 (i.e., along the axis 114). The eddy currents 122 oppose the first magnetic field 120 by reducing the strength of the magnetic field 120 that penetrates the pole 104 and the back plate 76. Reducing the strength of the magnetic field 120 during the transient period may reduce the strength of the eddy currents 124 induced in the rotating electrically conductive surface 58, thereby delaying the application of the desired braking force to the rotating electrically conductive surface 58. Accordingly, reducing the eddy currents 122 within the pole 104 and/or the back plate 76 during the transient period may increase the strength of the first magnetic field 120 and decrease the response time of the eddy current brake 74 to apply the desired braking force to the rotating electrically conductive surface 58.

When initially applying the eddy current brake 74 (e.g., initially supplying the current), the first magnetic field 120 generated as a result of the current in the one or more electrical windings 108 barely penetrates the pole 104 and the back plate 76 due to the eddy currents 122 generated in the pole 104 and the back plate 76. As the eddy current brake 74 is further applied (e.g., approximately 25 milliseconds after initially supplying the current), the first magnetic field 120 gradually penetrates into the pole 104 and the back plate 76 because the eddy currents 122 in the pole 104 and the back plate 76 begin to decay. Ultimately (e.g., approximately 3 seconds after initially supplying the current), the first magnetic field 120 is fully sustained (i.e., reached approximately 97% penetration into the pole 104 and the back plate 76) and, as a result, the first magnetic field 120 in the inductor 78 is maintained at full strength such that the first magnetic field 120 exerts a full braking force on the electrically conductive surface 58 by inducing the opposing second magnetic field 126 in the electrically conductive surface 58.

As may be appreciated, decreasing the eddy currents 122 in the one or more poles 104 and/or the back plate 76 of the eddy current brake 74 generated during the transient period when the current is initially supplied to the one or more electrical windings 108 results in generating the first magnetic field 120 in less time. Generating the first magnetic field 120 in less time results in inducing eddy currents 124 inside the electrically conductive surface 58 in less time, which results in generating the second magnetic field 126 in the electrically conductive surface 58 in less time. Because the braking force is a result of first magnetic field 120 opposing the second magnetic field 126, the net result of decreasing the eddy currents 122 in the pole 104 and/or the back plate 76 is a faster electromagnetic braking response time. That is, generating the first magnetic field 120 with the desired strength in less time enables faster control of the rotational speed of the shaft 56 by the eddy current brake 74.

The eddy currents 122 in the one or more poles 104 and the back plate 76 may be minimized by laminating portions of the one or more poles 104 and/or the back plate 76 by using one or more thin layers or sheets of magnetic material (known as laminations) and thin electrically insulating layers between the laminations. As described herein, the term “laminated” may be defined as having a plurality of laminations, wherein the plurality of laminations may be defined as a plurality of layers of magnetic material. It is envisioned that the plurality of laminations may be formed by a single sheet of magnetic material. For example, the single sheet of magnetic material may be wound in a spiral configuration such that the plurality of layers of magnetic material is formed. It is further envisioned that the plurality of laminations may be formed by more than one sheet of magnetic material. Electrical current cannot cross the insulating gap between the laminations and thus is prevented from flowing perpendicular to the planes of the laminations. As a result, the electrical current is forced to flow in a loop in the planes of the laminations. Because the eddy currents 122 in the one or more poles 104 and the back plate 76 flow in the circumferential direction 116, laminating portions 127 of the one or more poles 104 and/or the back plate 76 such that the ends of the lamination planes are approximately perpendicular (e.g., between 80° and 100°) to the direction of the first magnetic field 120 (i.e., along axis 114) may contain the eddy currents to the ends 128, 130 of the lamination planes, resulting in paths of smaller surface areas and ultimately less eddy currents 122.

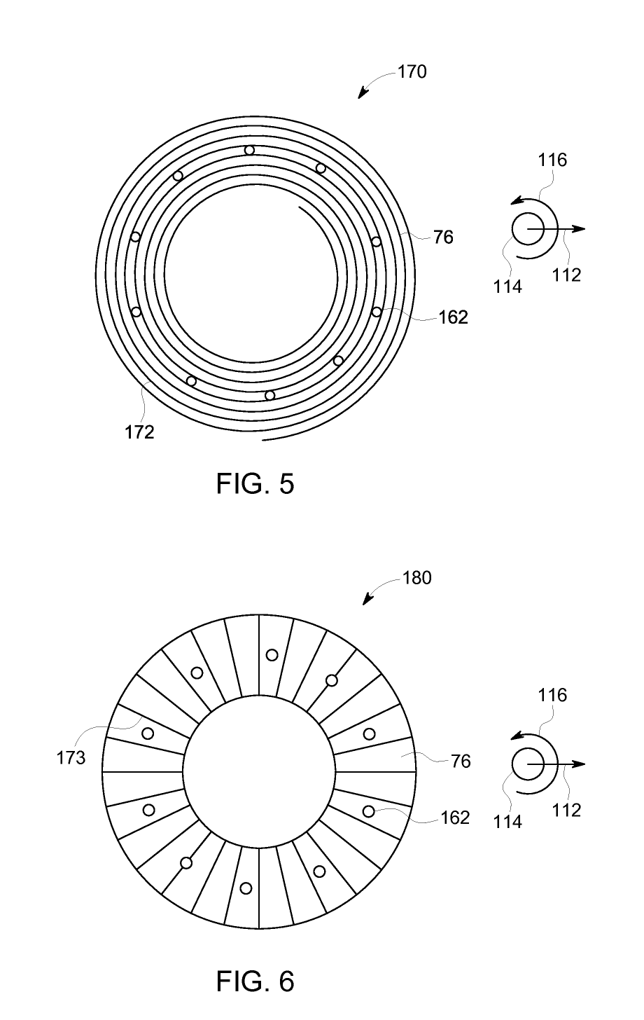

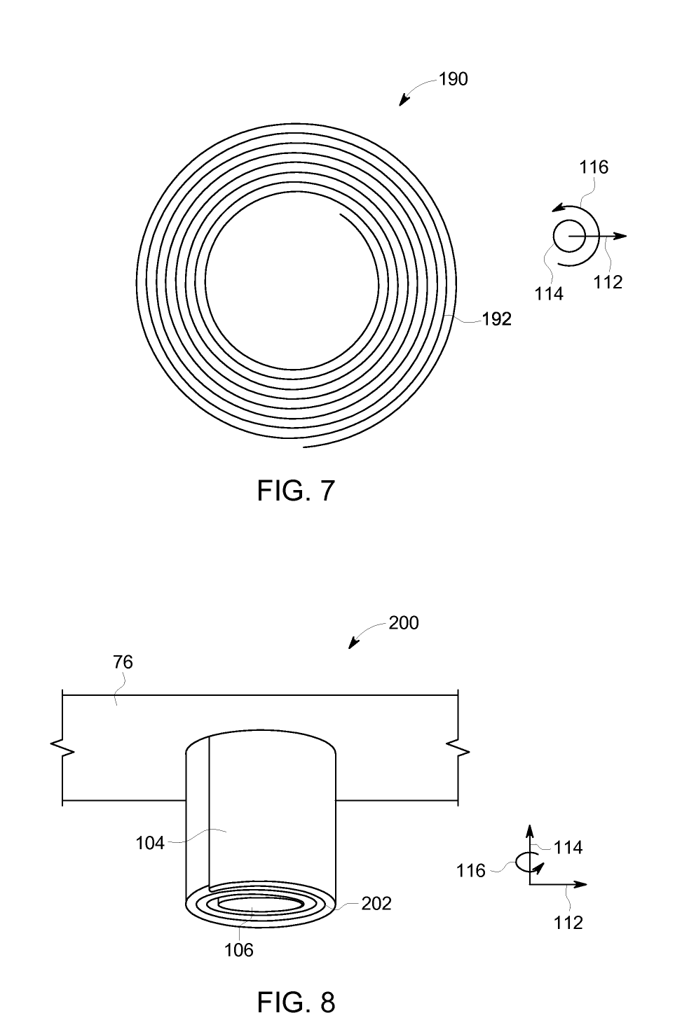

For example, FIG. 4 is an axial view 160 of a solid (i.e., unlaminated) back plate 76 of an embodiment of the electromagnetic braking system 52. Referring to FIG. 1, FIG. 4 represents the side 4 of the back plate that is further from the electrically conductive surface 58. One or more inductor fittings 162 enable the one or more inductors 78 to be coupled to the back plate 76. The back plate 76 may be laminated in certain configurations to reduce eddy currents 122. For example, FIG. 5 is an axial view 170 of a laminated back plate 76 of an embodiment of the electromagnetic braking system 52 constructed from laminations 172 arranged in a spiral pattern. The orientation of the laminations 172 in direction 116 approximately perpendicular to the direction 114 of the first magnetic field 120 reduces the eddy currents 122 generated in the back plate 76. As another example, FIG. 6 is an axial view 180 of a laminated back plate 76 of an embodiment of the electromagnetic braking system 52 constructed from radial laminations 173 arranged in a radial pattern. The orientation of the radial laminations 173 approximately perpendicular to the direction 114 of the first magnetic field 120 (i.e., along axis 112) reduces the flow of eddy currents 122 generated in the back plate 76. Likewise, the one or more poles 104 of the eddy current brake 74 may also be laminated in similar patterns (e.g., spiral, radial, etc.) such that the spiral and/or radial laminations of the poles 104 are oriented to reduce the eddy currents 122 generated in the poles 104. For example, FIG. 7 is an axial view 190 of a laminated pole 104 of an embodiment of the electromagnetic braking system 52 constructed from laminations 192 arranged in a spiral pattern. The laminated back plates 76 and/or poles 104 as illustrated in FIGS. 5-7 may minimize the eddy currents 122 that are generated when initially applying the eddy current brake 74 (e.g., initially supplying the current) as discussed above. As a result, the first magnetic field 120 generated as a result of the current in the one or more electrical windings 108 may more easily and quickly penetrate the laminated back plates 76 and/or poles 104. Because the back plates 76 and/or poles 104 are laminated such that the ends of the lamination planes are approximately perpendicular (e.g., between 80° and 100°) to the direction of the first magnetic field 120 (i.e., along axis 114) and the eddy currents 122 flow in the circumferential direction 116, the laminated back plates 76 and/or poles 104 may contain the eddy currents to the ends 128, 130 of the lamination planes, resulting in paths of smaller surface areas and ultimately less eddy currents 122.

In some embodiments, the back plate 76 and/or one or more poles 104 may be laminated as described above to reduce the eddy currents 122 generated within the eddy current brake 74 during the transient period when current is initially applied to the one or more electrical windings 108. That is, in some embodiments, at least one of the one or more poles 104 is laminated. Additionally, or in the alternative, the back plate 76 may be laminated. It is further contemplated that a combination of the one or more poles 104 and the back plate 76 may be laminated. As described herein, the term “laminated” may be defined as having a plurality of laminations, wherein the plurality of laminations may be defined as a plurality of layers of magnetic material. It is envisioned that the plurality of laminations may be formed by a single sheet of magnetic material. For example, the single sheet of magnetic material may be wound in a spiral configuration such that the plurality of layers of magnetic material is formed. It is further envisioned that the plurality of laminations may be formed by more than one sheet of magnetic material. Laminating at least one of the one or more poles 104 and the back plate 76 may significantly reduce eddy currents 122 in the one or more poles 104 and the back plate 76 generated by supplying current to the one or more electrical windings 108, and thus result in a faster electromagnetic braking response time. As may be appreciated, laminating at least some of the poles 104, the back plate 76, or some combination thereof, may reduce the eddy currents 122 within the eddy current brake 74 during the transient period with less effort and cost relative to fully laminating the same components. That is, it may be more cost-effective to laminate at least some of the poles 104, the back plate 76, or some combination thereof, rather than laminate each of the poles 104 and the back plate 76. Additionally, it is contemplated that at least some of the poles 104, the back plate 76, or some combination thereof, are laminated such that the at least some of the poles 104, the back plate 76, or some combination thereof includes a plurality of laminations, but are not entirely composed of the plurality of laminations. For example, referring to FIG. 3, it is contemplated that the eddy current brake 74 may include a laminated back plate 76 and a laminated pole 104, such that the core 106 of the pole 104 is solid (i.e., unlaminated), but the remainder 110 of the pole 104 is laminated. FIG. 8 is a cross-sectional view 200 of the laminated pole 104 (i.e., along axis 112) of the eddy current brake 74 that includes the plurality of laminations 202 and the solid core 106. The laminated pole 104 is coupled (e.g., mounted) to the back plate 76 and includes the plurality of laminations 202 in a spiral pattern.

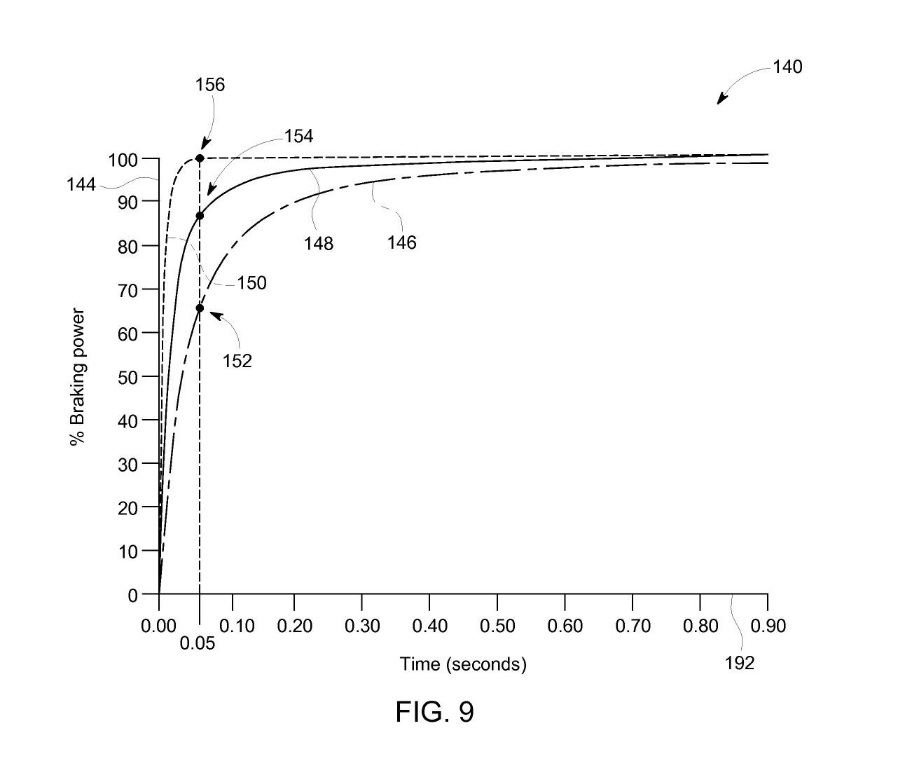

FIG. 9 is a chart illustrating the response time of various embodiments of the electromagnetic braking system, specifically comparing the percentage of electromagnetic braking power of an embodiment of the eddy current brake 74 with solid (i.e., unlaminated) portions and/or laminated portions. The horizontal axis 142 represents time in seconds. The vertical axis 144 represents the percentage of electromagnetic braking power capable by various embodiments of eddy current brakes 74, where 100% is the maximum desired braking power. The bottom curve 146 represents the braking power of a first eddy current brake 74 with a solid pole 104 and a solid back plate 76 and shows: at 0.10, 0.20, and 0.30 seconds, the braking power is approximately 87%, 89%, and 93%, respectively. Specifically, at 50 milliseconds (0.05 seconds), the braking power 152 of the first eddy current brake 74 is at approximately 61%. At 0.90 seconds, the braking power of the first eddy current brake 74 has not yet reached 100%. By comparison, the middle curve 148 represents the braking power of a second eddy current brake 74 with a laminated pole 104 and a solid back plate 76 and shows: at 0.10, 0.20, and 0.30 seconds, the braking power is approximately 92%, 96%, and 98%, respectively. Specifically, at 50 milliseconds, the braking power 154 of the second eddy current brake 74 is at approximately 83%. Finally, the top curve 150 represents the braking power of a third eddy current brake 74 with a laminated pole 104 and a laminated back plate 76 and shows that by 0.05 seconds, the braking power has substantially reached 100%. Specifically, at 50 milliseconds, the braking power 156 of the third eddy current brake 74 is at approximately 99%. It is contemplated that in some embodiments, at least 80% of the braking power of the eddy current brake 74 is applied 50 milliseconds after the eddy current brake 74 is applied. It is further contemplated that in some embodiments, at least 90% of the braking power of the eddy current brake 74 is applied 50 milliseconds after the eddy current brake 74 is applied.

It is also envisioned that the laminated components of the eddy current brake 74 may be constructed with silicon alloying. Alloying, for example, at least one of the one or more poles 104 and the back plate 76 with an amount of silicon would also decrease the eddy currents 122 in the one or more poles 104 and the back plate 76 generated when supplying current to the one or more electrical windings 108. The amount of silicon in the alloyed one or more poles 104 and/or back plate 76 may be between 0.1% and 5%, 1% and 4%, or 2.5% and 3.5%. It is contemplated that silicon alloying may be combined with laminating components of the eddy current brake 74. For example, it is contemplated that the eddy current brake 74 include one or more laminated poles 104 that are made with a silicon alloy, a laminated back plate 76 that is made with a silicon alloy, or any combination thereof.

Technical effects of the subject matter disclosed herein include, but are not limited to, electromagnetic braking of a generator of a power generation system during an LVRT event. It would be desirable to reduce the response time of the electromagnetic brake. Applying an electromagnetic brake (e.g., eddy current brake) includes supplying current to one or more windings in at least one inductor of the eddy current brake to generate a magnetic field that penetrates at least one pole of the at least one inductor and back plate. Decreasing the time it takes to generate the first magnetic field in the at least one inductor results in decreasing the response time of the electromagnetic brake. Because eddy currents build up in the at least one pole and the back plate in response to supplying current to the one or more windings and prevent the magnetic field from penetrating the at least one pole and the back plate, decreasing the eddy currents in the at least one pole and/or the back plate generated in response to supplying current to the one or more windings results in decreasing the response time of the eddy current brake. Thus, laminating at least one pole of the at least one inductor or the back plate of the eddy current brake would result in decreasing the braking response time and, consequently, less energy expended in providing the braking force. This written description uses examples to disclose the subject system and method, including the best mode, and also to enable any person skilled in the art to practice the subject system and method, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
an eddy current brake comprising:
a back plate; and
a first inductor, the first inductor comprising:
a pole coupled to the back plate and a winding disposed about the pole, wherein the winding is configured to conduct an electric current to generate a magnetic field;
wherein at least one of the back plate and the pole comprises a plurality of laminations.

2. The system of claim 1, wherein the back plate is fully laminated.

3. The system of claim 1, wherein the back plate comprises a first plurality of laminations and the pole comprises a second plurality of laminations.

4. The system of claim 1, wherein the plurality of laminations comprise a silicon steel alloy.

5. The system of claim 1, comprising a power source coupled to the winding, wherein the power source is configured to supply the electric current during activation of the eddy current brake, the electric current comprises at least 70 percent of a steady-state current value within 10 ms of activation of the eddy current brake, and the magnetic field comprises at least 80 percent of a steady-state magnetic field strength within 50 ms of activation of the eddy current brake.

6. The system of claim 1, comprising a power source coupled to the winding, wherein the power source is configured to supply the electric current during activation of the eddy current brake, the electric current comprises at least 70 percent of a steady-state current value within 10 ms of activation of the eddy current brake, and the magnetic field comprises at least 90 percent of a steady-state magnetic field strength within 50 ms of activation of the eddy current brake.

7. The system of claim 1, wherein the eddy current brake comprises an electrically conductive surface coupled to a shaft of a generator system, and the magnetic field is configured to resist rotation of the electrically conductive surface and the shaft during activation of the eddy current brake.

8. The system of claim 7, comprising the generator system, wherein the generator system comprises the shaft, a prime mover coupled to the shaft, and a generator coupled to the shaft, wherein the generator is coupled to a power grid.

9. The system of claim 8, wherein the prime mover comprises a reciprocating engine.

10. A system comprising:
an electromagnetic braking system, comprising:
an eddy current brake, comprising:
an electrically conductive surface coupled to a shaft of a generator system;
a back plate and a plurality of inductors coupled to the back plate, each inductor comprising:
a pole coupled to the back plate and a winding disposed about the pole, wherein the winding is configured to conduct an electric current to generate a first magnetic field;
wherein at least one of the back plate and each respective pole comprises a plurality of laminations.

11. The system of claim 10, wherein the back plate is fully laminated.

12. The system of claim 10, wherein each respective pole comprises a first plurality of laminations.

13. The system of claim 10, wherein the back plate comprises a second plurality of laminations.

14. The system of claim 10, wherein the plurality of inductors comprises at least four inductors.

15. The system of claim 10, comprising a controller coupled to the eddy current brake, wherein the controller is configured to determine a start of a ride through event and to supply the electric current to the respective windings of each inductor of the plurality of inductors to generate the magnetic field to oppose rotation of the electrically conductive surface upon determination of the start of the ride through event.

16. The system of claim 15, wherein the magnetic field comprises at least 80 percent of a steady-state magnetic field strength within 50 ms of activation of the eddy current brake.

17. A method comprising:
monitoring a load parameter of the power generation system;
determining a start of a ride through event based at least in part on a first change to the load parameter; and
applying an eddy current brake to load the power generation system through the ride through event, wherein applying the eddy current brake comprises:
supplying an electric current to a winding of the eddy current brake, wherein the electric current comprises at least 70 percent of a steady-state current value within a threshold time period of the start of the ride through event; and
inducing, via the current through the winding, an electromagnetic force on an electrically conductive surface of the eddy current brake, wherein the eddy current brake comprises the electrically conductive surface, a back plate and a pole coupled to the back plate, and at least one of the back plate and the pole comprises a plurality of laminations.

18. The method of claim 17, wherein the induced electromagnetic force on the electrically conductive surface comprises at least 80 percent of a steady-state magnetic field strength within 50 ms of activation of the eddy current brake.

19. The method of claim 17, wherein the pole comprises the plurality of laminations.

20. The method of claim 17, wherein the power generation system comprises a reciprocating engine.
